(19) United States
(12) Patent Application Publication
(10) Pub. No.: US 2024/0393034 A1
(43) Pub. Date: Nov. 28, 2024

(54) REFRIGERATOR

(71) Applicant: SAMSUNG ELECTRONICS CO., LTD., Suwon-si (KR)

(72) Inventors: Kenji TAKEUCHI, Yokohama-shi (JP); Shingo IMANO, Yokohama-shi (JP)

(21) Appl. No.: 18/792,568

(22) Filed: Aug. 2, 2024

Related U.S. Application Data
(63) Continuation of application No. PCT/KR2023/001513, filed on Feb. 2, 2023.

(30) Foreign Application Priority Data
Mar. 4, 2022 (JP) 2022-033503

(51) Int. Cl. F25D 23/06

(52) U.S. Cl. CPC F25D 23/065; F25D 2201/122

(57) ABSTRACT

A refrigerator includes an outer wall member, an inner wall member, and an insulation member therebetween. At least a portion of the inner wall member includes a foam layer, an inner layer, and an outer layer. The foam layer includes closed cells. The inner layer and the outer layer are respectively laminated on opposite sides of the foam layer.

### CROSS-REFERENCE TO RELATED APPLICATIONS

This application is a continuation application, under 35 U.S.C. § 111 (a), of International Patent Application No. PCT/KR2023/001513, filed on Feb. 2, 2023, which claims priority to Japanese Patent Application No. 2022-033503, filed on Mar. 4, 2022, the content of which in its entirety is herein incorporated by reference.

### FIELD

The disclosure relates to a refrigerator.

### BACKGROUND ART

Because a temperature difference occurs between the inside and outside of a refrigerator, condensation may form near a door where cold from the inside of the refrigerator easily leaks out. In Japanese Patent Publication No. 2010-249491, provided is a technology for suppressing the formation of condensation by placing a heater near a door where condensation is likely to form.

### SUMMARY

According to a feature of the disclosure, a refrigerator may include an outer wall member that forms an outer wall of a main body, and an inner wall member that is disposed inside the outer wall member and forms a space to be cooled therein. An insulation member may be between the outer wall member and the inner wall member. At least a portion of the inner wall member may include a foam layer including closed cells, and an inner layer and an outer layer respectively laminated on opposite sides of the foam layer.

### DESCRIPTION OF DRAWINGS

The above and other exemplary embodiments, advantages and features of this disclosure will become more apparent by describing in further detail exemplary embodiments thereof with reference to the accompanying drawings, in which:

FIG. 1 is a front view of an embodiment of a refrigerator according to the disclosure.

FIG. 2 is a cross-sectional view of the refrigerator taken along line F-F of FIG. 1.

FIG. 3A is a schematic diagram showing an embodiment of the shape of a refrigerator resin part, and FIG. 3B is a cross-sectional view of the refrigerator resin part shown in area A of FIG. 3A according to the disclosure.

FIG. 4 is an enlarged cross-sectional schematic diagram of an embodiment of a refrigerator resin part according to the disclosure.

FIG. 5 is a schematic diagram showing an embodiment of the shape of cells before and after a foam layer is formed, according to the disclosure.

FIG. 6 is a graph showing an embodiment of the relationship between an aspect ratio (D/C) of a closed cell in a foam layer and thermal conductivity of a refrigerator resin part in a thickness direction, according to the disclosure.

FIG. 7 is a cross-sectional photograph of an embodiment of a foam layer of a refrigerator resin part, according to the disclosure.

FIG. 8 is an enlarged cross-sectional photograph of an embodiment of a foam layer of a refrigerator resin part, according to the disclosure.

FIG. 9 is a graph showing the relationship between thermal conductivity of a refrigerator resin part and temperature of an outer wall.

FIG. 10 is a graph showing the relationship between an average thickness of a refrigerator resin part and energy saving performance of a refrigerator.

FIG. 11A is a graph showing the relationship between a mixing ratio of foamable fine particles in a foam layer and density of the foam layer.

FIG. 11B is a graph showing the relationship between density of a foam layer and thermal conductivity of the foam layer.

### MODE FOR INVENTION

It should be understood that the various embodiments of the disclosure and the terms used herein are not intended to limit the technical features described in the disclosure to illustrative embodiments, and include various modifications, equivalents, or alternatives of corresponding embodiments.

In relation to the description of drawings, like reference numerals may denote like or relevant components.

The singular form of a noun corresponding to an item may include one item or a plurality of items, unless the relevant context clearly indicates otherwise.

In the disclosure, each of the phrases “A or B”, “at least one of A and B”, “at least one of A or B”, “A, B, or C”, “at least one of A, B, and C”, and “at least one of A, B, or C” may include any one of items listed together in the corresponding phrase, or any possible combinations thereof.

The term “and/or” includes any component of a plurality of relevant components described herein or any combination of the plurality of relevant components described herein.

The terms “first”, “second”, or “first” or “second” may be simply used to distinguish a component from another component and do not limit the components in other features (e.g., importance or order).

In addition, the terms “front”, “rear”, “top”, “bottom”, “side”, “left”, “right”, “upper”, and “lower” used herein are defined based on the drawings, and the shape and location of each component are not limited by these terms.

The terms “include”, “comprise”, or “have” are intended to indicate the presence of features, numbers, steps, operations, components, parts, or combinations thereof described herein, and do not preclude the presence or addition of one or more other features, numbers, steps, operations, components, parts, or combinations thereof.

When a certain component is “connected”, “coupled”, “supported”, or “in contact” with another component, this includes a case where the components are directly connected, coupled, supported, or in contact with each other and a case where the components are indirectly connected, coupled, supported, or in contact with each other via another component.

When a certain component is disposed “on” another component, this includes a case where the certain component is in contact with the other component and a case where another component is between the two components.

In an embodiment, a refrigerator may include a main body.

The “main body” may include an inner box, an outer box disposed outside the inner box, and an insulation material between the inner box and the outer box.

The “inner box” may include at least one of a case, a plate, a panel, or a liner, which forms a storage compartment. The inner box may be formed as a single body or may be formed by assembling a plurality of plates. The “outer box” may form the exterior of the main body and may be joined to the outside of the inner box such that the insulation material is between the inner box and the outer box.

The “insulation material” may insulate the inside and outside of the storage compartment such that the internal temperature of the storage compartment may be maintained at a set appropriate temperature without being affected by the environment outside the storage compartment. In an embodiment, the insulation material may include a foam insulation material. The foam insulation material may be formed by injecting, into a space between the inner box and the outer box, and foaming urethane foam in which polyurethane and a foaming agent are mixed.

In an embodiment, the insulation material may further include a vacuum insulation material in addition to the foam insulation material, or the insulation material may include only the vacuum insulation material instead of the foam insulation material. The vacuum insulation material may include a core material and a covering material that accommodates the core material and seals the interior with vacuum or near-vacuum pressure. However, the insulation material is not limited to the foam insulation material or vacuum insulation material described above and may include various materials that may be used for insulation.

The “storage compartment” may define a space limited by the inner box. The storage compartment may further include an inner box that limits a space corresponding to the storage compartment. The storage compartment may store various types of products such as food, medicine, and cosmetics, and the storage compartment may be formed so that at least one side thereof is open to put products in or out of the storage compartment.

The refrigerator may include one or more storage compartments. When two or more storage compartments are formed in the refrigerator, the respective storage compartments may have different purposes and be maintained at different temperatures. To this end, each storage compartment may be partitioned off from each other by a partition wall including an insulation material.

The storage compartment may be provided to be maintained at an appropriate temperature range according to the purpose and may include a “refrigerator compartment”, a “freezer compartment”, or a “temperature-changing compartment”, which is classified according to the purpose and/or temperature range. The refrigerator compartment may be maintained at an appropriate temperature to keep products refrigerated, and the freezer compartment may be maintained at an appropriate temperature to keep products frozen. “Refrigerated” may refer to keeping products cold without freezing the products. In an embodiment, the refrigerator compartment may be maintained in a range of about 0° C. to about +7° C. “Frozen” may refer to freezing products or cooling the products such that the products remain frozen, for example. In an embodiment, the freezer compartment may be maintained in a range of about −20° C. to about −1° C., for example. The temperature-changing compartment may be used as either a refrigerator compartment or a freezer compartment, with or without selection of a user.

In addition to the names such as “refrigerator compartment”, “freezer compartment”, and “temperature-changing compartment”, the storage compartment may be also referred to as various names such as “vegetable compartment”, “fresh product compartment”, “cooling compartment”, and “ice making compartment”. The terms “refrigerator compartment”, “freezer compartment”, and “temperature-changing compartment” used below should be understood to encompass storage compartments having corresponding purposes and temperature ranges, respectively.

In an embodiment, the refrigerator may include at least one door configured to open or close one open side of the storage compartment. The door may be provided to open or close one or more storage compartments, or a single door may be provided to open or close a plurality of storage compartments. The door may be rotatably or slidingly provided on the front of the main body.

The “door” may seal the storage compartment when the door is closed. Like the main body, the door may include an insulation material to insulate the storage compartment when the door is closed.

In an embodiment, the door may include an outer door plate that forms the front of the door, an inner door plate that forms the rear of the door and faces the storage compartment, an upper cap, a lower cap, and a door insulation material provided inside these components.

A gasket may be provided on the edge of the inner door plate, the gasket sealing the storage compartment by being closely attached to the front of the main body when the door is closed. The inner door plate may include a dyke that protrudes rearward such that a door basket for storing products is disposed (e.g., mounted).

In an embodiment, the door may include a door body and a front panel that is detachably coupled to the front of the door body and forms the front of the door. The door body may include an outer door plate that forms the front of the door body, an inner door plate that forms the rear of the door body and faces the storage compartment, an upper cap, a lower cap, and a door insulation material provided inside these components.

According to the arrangement of the door and the storage compartment, the refrigerator may be classified into a French door type refrigerator, a side-by-side type refrigerator, a bottom mounted freezer (BMF) refrigerator, a top mounted freezer (TMF) refrigerator, or a one-door refrigerator.

In an embodiment, the refrigerator may include a cold air supply apparatus provided to supply cold air to the storage compartment.

The “cold air supply apparatus” may include a machine, an appliance, or an electronic apparatus capable of generating cold air and directing the cold air to cool a storage compartment, and/or a system including any combination thereof.

In an embodiment, the cold air supply apparatus may generate cold air through a refrigeration cycle including compression, condensation, expansion, and evaporation processes of a refrigerant. To this end, the cold air supply apparatus may include a refrigeration cycle apparatus including a compressor, a condenser, an expansion apparatus, and an evaporator capable of driving the refrigeration cycle. In an embodiment, the cold air supply apparatus may include a semiconductor such as a thermoelectric element. The thermoelectric element may cool the storage compartment through heat generation and cooling using the Peltier effect.

In an embodiment, the refrigerator may include a machine compartment in which at least some parts of the cold air supply apparatus are disposed.

The “machine compartment” may be partitioned and insulated from the storage compartment to prevent heat generated from parts placed in the machine compartment from being transferred to the storage compartment. The inside of the machine compartment may communicate with the outside of the main body to dissipate heat from the parts placed inside the machine compartment.

In an embodiment, the refrigerator may include a dispenser provided on the door to provide water and/or ice. The dispenser may be provided on the door such that a user may access the dispenser without opening the door.

In an embodiment, the refrigerator may include an ice making apparatus provided to produce ice. The ice making apparatus may include an ice making tray that stores water, an ice moving apparatus that separates ice from the ice making tray, and an ice bucket that stores ice produced in the ice making tray.

In an embodiment, the refrigerator may include a controller for controlling the refrigerator.

The “controller” may include a memory that stores programs and/or data for controlling the refrigerator, and a processor that outputs control signals for controlling the cold air supply apparatus according to the programs and/or data stored in the memory.

The memory stores or records various types of information, data, instructions, programs, etc., desired for the operation of the refrigerator. The memory may store temporary data generated while generating control signals for controlling components included in the refrigerator. The memory may include at least one of a volatile memory or a nonvolatile memory or any combinations thereof.

The processor controls all operations of the refrigerator. The processor may control the components of the refrigerator by executing the programs stored in the memory. The processor may include a separate neural network processing unit (NPU) that performs operations of an artificial intelligence model. Also, the processor may include a central processing unit, a graphic processing unit (GPU), or the like. The processor may generate a control signal for controlling the operation of the cold air supply apparatus. In an embodiment, the processor may receive temperature information about the storage compartment from a temperature sensor and generate a cooling control signal for controlling the operation of the cold air supply apparatus based on the temperature information about the storage compartment, for example.

Also, the processor may process a user input from a user interface according to the programs and/or data stored in the memory and control the operation of the user interface. The user interface may be provided by an input interface and an output interface. The processor may receive a user input from the user interface. Also, the processor may transmit, to the user interface, a display control signal and image data for displaying an image on the user interface in response to the user input.

The processor and the memory may be provided as a single body or may be provided separately. The processor may include one or more processors. In an embodiment, the processor may include a main processor and at least one sub-processor. The memory may include one or more memories, for example.

In an embodiment, the refrigerator may include a memory and a processor that controls all of the components included in the refrigerator, and may include a plurality of memories and a plurality of processors that individually control the components of the refrigerator. In an embodiment, the refrigerator may include a memory and a processor that controls the operation of the cold air supply apparatus according to an output of the temperature sensor, for example. Also, the refrigerator may separately include a memory and a processor that controls the operation of the user interface according to the user input.

A communication module may communicate with external apparatuses such as a server, a mobile apparatus, or other home appliances through a nearby access point (AP). The AP may connect a local area network (LAN) to which a refrigerator or user device is connected to a wide area network (WAN) to which a server is connected. The refrigerator or user device may be connected to the server through a WAN.

The input interface may include a key, a touch screen, a microphone, or the like. The input interface may receive a user input and transmit the user input to the processor.

The output interface may include a display, a speaker, or the like. The output interface may output various notifications, messages, or information generated by the processor.

Condensation may form near the door of the refrigerator due to a temperature difference between the inside and outside of the refrigerator. Placing a heater near the door to prevent condensation may be considered. In this case, heat from the heater may enter the inside of the refrigerator, which may increase power consumption of the refrigerator. Accordingly, there is a need for a method of reducing the formation of condensation without using a heater or the like.

In order to reduce the formation of condensation near the door without having a heater or the like, it is desired to reduce the amount of heat leaking from the inside of the refrigerator to the outside. To this end, a method of forming not only the insulation member, such as urethane, accommodated between a part, such as the inner box that forms an inner wall of the refrigerator, and an outer wall of the refrigerator but also a part, such as the inner box, with a foam resin having relatively low thermal conductivity may be considered. When these parts are formed with a foam resin, the thermal conductivity may be lowered, but the designability of the inner wall of the refrigerator may be damaged due to irregularities caused by cells in the foam resin on the surfaces of these parts.

The disclosure provides a refrigerator resin part that may achieve both relatively low thermal conductivity and designability, and a refrigerator employing the same. Embodiments of the disclosure will now be described with reference to accompanying drawings.

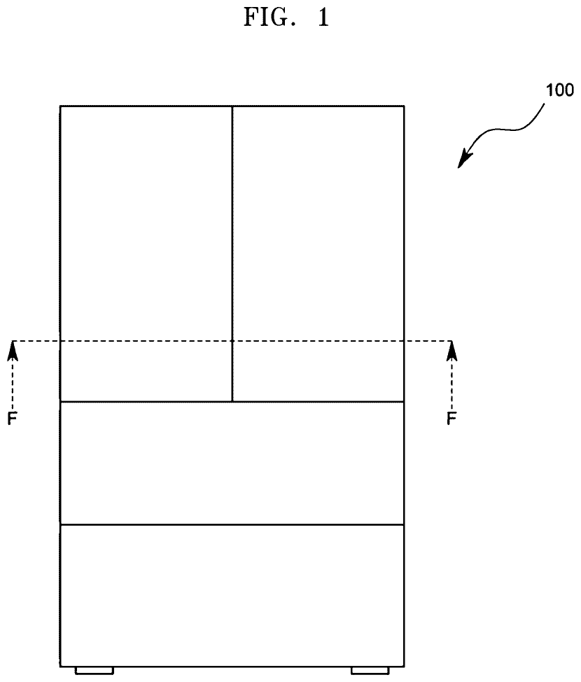

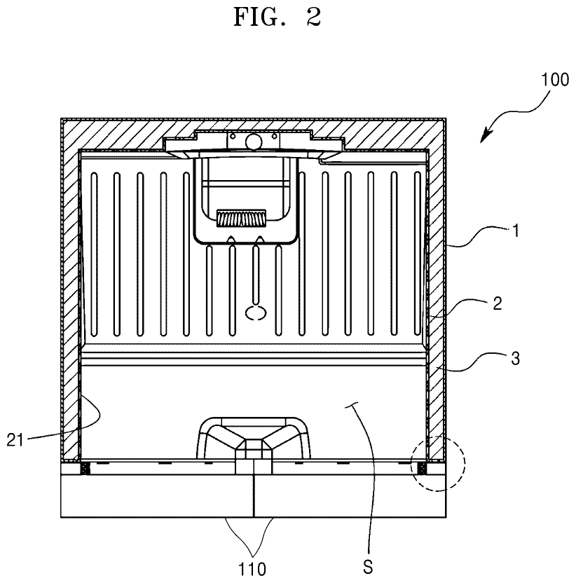

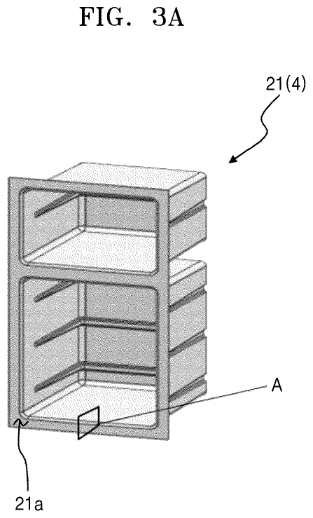

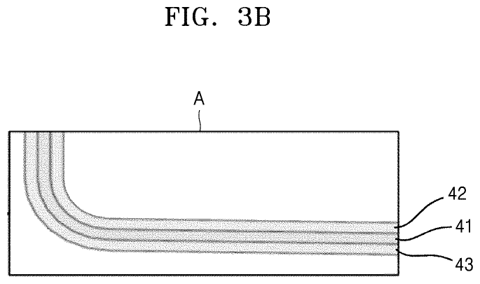

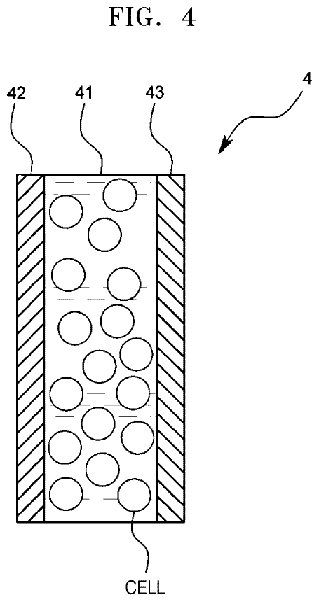

FIG. 1 is a schematic front view of an embodiment of a refrigerator 100 according to the disclosure. FIG. 2 is a cross-sectional view of the refrigerator taken along line F-F of FIG. 1. Referring to FIGS. 1 and 2, the refrigerator 100 may include an outer wall member 1 that forms an outer wall of a main body of the refrigerator 100, an inner wall member 2 that is disposed inside the outer wall member 1 and defines a space S to be cooled therein, and an insulation member 3 between the outer wall member 1 and the inner wall member 2, for example. At least a portion of the inner wall member 2 may be formed by a refrigerator resin part 4 (refer to FIGS. 3A to 4, for example) to be described below.

The outer wall member 1 forms an outer wall (outer surface) of the refrigerator 100, for example. In more detail, the outer wall member 1 forms a surface in direct contact with outside air, such as an outer box of the refrigerator 100 or an outer wall of a door. The inner wall member 2 forms an inner surface of the space S to be cooled formed inside the refrigerator 100, for example. The inner wall member 2 forms a surface in direct contact with cold air in the space S to be cooled, such as an inner box of the refrigerator 100 or an inner surface of the door. The insulation member 3 is disposed between the outer wall member 1 and the inner wall member 2 to suppress the transfer of heat between the space S to be cooled and the outside to a relatively low level. In an embodiment, the insulation member 3 may be formed with a foam resin such as urethane, for example.

The inner wall member 2 includes an inner box formation member 21 that forms the inner surface of the space S to be cooled. FIG. 3A is a schematic diagram showing an embodiment of the shape of the refrigerator resin part 4, and FIG. 3B is a cross-sectional view of the refrigerator resin part 4 shown in area A of FIG. 3A according to the disclosure. FIG. 4 is an enlarged cross-sectional schematic diagram of an embodiment of the refrigerator resin part 4 according to the disclosure, shown in FIGS. 3A and 3B. Referring to FIGS. 3A to 4, at least a portion of the inner box formation member 21 may be the refrigerator resin part 4, for example. The refrigerator resin part 4 may include a foam layer 41, and an inner layer 42 and an outer layer 43, which are non-foam layers respectively disposed (laminated) on opposite sides of the foam layer 41. An outer surface of the inner layer 42 forms an inner wall of the refrigerator, which is visible to a user when a door 110 is opened. That is, the outer surface of the inner layer 42 is in direct contact with cold air in the space S to be cooled. An outer surface of the outer layer 43 contacts the insulation member 3. In the illustrated embodiment, these three layers 41, 42, and 43 are directly attached to each other without having an adhesive layer or the like therebetween.

The foam layer 41 includes closed cells. In an embodiment, the foam layer 41 may have closed cells formed inside a resin layer including polystyrene. The density of the foam layer 41 may be at least about 0.1 gram per cubic centimeter (g/cm³) but no more than about 0.5 g/cm³, for example. When the density of the foam layer 41 is 0.1 g/cm³ or more, the foam layer 41 may have a shape or strength suitable for use as a refrigerator part. Also, when the density of the foam layer 41 is 0.5 g/cm³ or less, the thermal conductivity of the foam layer 41 may be sufficiently lowered. In an embodiment, the density of the foam layer 41 may be 0.4 g/cm³ or less, for example.

An average thickness of the foam layer 41 may be appropriately changed according to the purpose or desired thermal conductivity. In the disclosure, an expression “an average thickness of a layer” may mean a value obtained by averaging thicknesses of the layer in different measure points, respectively, of the layer, for example. In an embodiment, the average thickness of the foam layer 41 may be at least about 0.1 millimeter (mm) but no more than about 1.5 mm, may be preferably at least about 0.3 mm but no more than about 1.0 mm, and more preferably at least about 0.4 mm but no more than about 0.9 mm, for example.

Various grades of polystyrene may be used. Also, polystyrene may preferably include high impact polystyrene or high strain hardening polystyrene.

The closed cells may be formed by foamable fine particles, for example. An average diameter of respective diameters of the foamable fine particles may be preferably about 100 micrometers (μm) or less. The foamable fine particles include a deformable microcapsule including resin or the like, and an expansion agent (e.g., hydrocarbons) included in the microcapsule. When the foamable fine particles are heated, the hydrocarbons therein are vaporized and the microcapsule expands. As the foamable fine particles, commercially available materials may be used. A diameter of the foamable fine particles after thermal expansion, that is, an average diameter of respective diameters of the closed cells, may be preferably 200 μm or less, e.g., at least about 50 μm but no more than about 190 μm. Heating temperature may be appropriately changed to control an expansion rate.

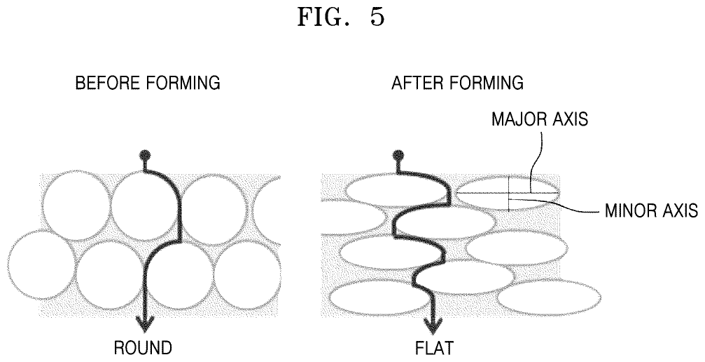

FIG. 5 is a schematic diagram showing an embodiment of the shape of cells before and after the foam layer 41 is formed, according to the disclosure. In an embodiment, the shape of the closed cell may preferably be a flat shape extending in a direction (e.g., horizontal direction in FIG. 5) perpendicular to a thickness direction (e.g., vertical direction in FIG. 5) of the foam layer 41, as shown in FIG. 5, for example. In an embodiment, an expression “a thickness direction of a layer” may mean a direction perpendicular to a main plane extension direction of the layer. An aspect ratio of the closed cell, that is, a ratio (D/C) of the length (D) of a minor axis to the length (C) of a major axis of the closed cell may be preferably at least about 0.2 but no more than about 0.9, more preferably at least about 0.3 but no more than about 0.7, and particularly preferably at least about 0.4 but no more than about 0.6.

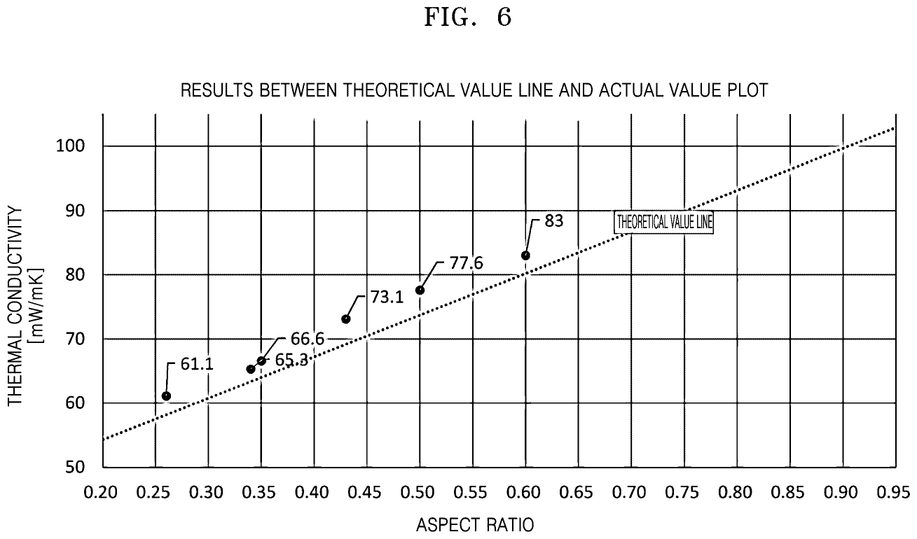

FIG. 6 is a graph showing an embodiment of the relationship between an aspect ratio (D/C) of a closed cell in the foam layer 41 and thermal conductivity of the refrigerator resin part 4 in a thickness direction, according to the disclosure. Results of examining the relationship between the aspect ratio (D/C) and thermal conductivity by samples with variously changed aspect ratios (D/C) are shown in FIG. 6. From the results of FIG. 6, it may be identified that, with respect to the relationship between the aspect ratio (D/C) and thermal conductivity, a theoretical value line representing theoretical values and a plot of actual values measured for actual samples are substantially well correlated. From the results of FIG. 6, it may be identified that, in order to keep the thermal conductivity of the refrigerator resin part 4 in the thickness direction in a sufficiently low range (e.g., 100 milliwatts per meter-kelvin (mW/m-K) or less), the aspect ratio (D/C) of the closed cell is preferably 0.9 or less. Also, in a process of stretching a resin sheet when forming the refrigerator resin part 4, the aspect ratio (D/C) of the closed cell may be preferably 0.2 or more, in order to prevent inner surfaces of resin covering the closed cells in the thickness direction from coming into close contact with each other due to breakage of the closed cells or breakage of the resin covering the closed cells, or due to the length (D) of the minor axis of the closed cell becoming too short.

Major axes of the closed cells may preferably be arranged side by side in the direction perpendicular to the thickness direction of the foam layer 41. The maximum inclination of the major axis of the closed cell with respect to the direction perpendicular to the thickness direction of the foam layer 41 may be more preferably within +15 degrees, i.e., equal to or less than +15 degrees and equal to or greater than-15 degrees, for example.

The inner layer 42 and the outer layer 43 may be formed with an acrylonitrile-butadiene-styrene copolymer (ABS) resin, for example. The inner layer 42 and the outer layer 43 are non-foam layers that include almost no cells therein. The density of each of the inner layer 42 and the outer layer 43 may be preferably greater than 0.5 g/cm³. The inner layer 42 and the outer layer 43 may preferably not include cells as much as possible.

The thermal conductivity of the inner layer 42 and/or outer layer 43 in the thickness direction may be preferably at least about 100 mW/m·K but no more than about 300 mW/m·K, more preferably 250 mW/m·K or less, and particularly preferably 200 mW/m-K or less.

When an average thickness of the inner layer 42 is too small, irregularities of the foam layer 41 may appear on the outer surface of the inner layer 42. Considering this, the average thickness of the inner layer 42 may be 0.55 mm or more. As the average thickness of the inner layer 42 is greater, irregularities are less likely to occur on the outer surface of the inner layer 42. Accordingly, the average thickness of the inner layer 42 may be preferably greater. However, in order not to change the internal volume, that is, the volume of the space S to be cooled, the thickness of the insulation member 3 needs to be relatively small as the thickness of the inner layer 42 increases, and thus, the insulation performance of the refrigerator 100 may deteriorate. Also, when the average thickness of the inner layer 42 is too large, heat is not uniformly transferred during vacuum thermoforming of the refrigerator resin part 4, which may cause formation defects and increase the heating time for sufficient heating, thereby increasing the thermoforming process time. Considering this, the average thickness of the inner layer 42 may be preferably 1.5 mm or less, and more preferably 1.0 mm or less.

In a structure in which only one side of the foam layer 41 is covered with the inner layer 42, when a resin sheet including the foam layer 41 and the inner layer 42 is heated for thermoforming, secondary foaming may occur in the foam layer 41, or the resin sheet may be excessively stretched, causing irregularities of the foam layer 41 on the outer surface of the inner layer 42. Considering this, the refrigerator resin part 4 of the disclosure covers opposite sides of the foam layer 41 with the inner layer 42 and the outer layer 43. Accordingly, the foam layer 41 may lower the thermal conductivity and the formation of irregularities of the foam layer 41 on the outer surface of the inner layer 42 may be suppressed, thereby ensuring sufficient designability.

Considering the above, a ratio (A/B) of an average thickness (B) of the outer layer 43 to an average thickness (A) of the inner layer 42 may be 2.5 or less. The ratio (A/B) of the average thicknesses may be more preferably 2.0 or less, and particularly preferably 1.8 or less. In an embodiment, because the minimum value of the average thickness (A) of the inner layer 42 is 0.55 mm, the average thickness of the outer layer 43 may be 0.24 mm or more to satisfy a condition of A/B≤2, and may be more preferably 0.3 mm or more to satisfy a condition of A/B≤1.8. Also, similar to the aforementioned inner layer 42, when the average thickness of the outer layer 43 is too large, formation defects may occur or the process time may be prolonged during vacuum thermoforming of the refrigerator resin part 4, and the thickness of the insulation member 3 decreases, which may cause deterioration of the insulation performance of the refrigerator 100, for example. Thus, the average thickness of the outer layer 43 may be preferably 1.0 mm or less, more preferably 0.5 mm or less, and particularly preferably 0.4 mm or less.

The average thickness (A) of the inner layer 42, the average thickness (B) of the outer layer 43, and an average thickness (E) of the foam layer 41 described above may preferably satisfy Formula (1) below.

$$E / ( A + B ) \leq 1. \qquad ( 1 )$$

A total thickness (sum of the average thickness of the foam layer 41, the average thickness of the inner layer 42, and the average thickness of the outer layer 43) of the refrigerator resin part 4 may be preferably at least about 1.0 mm but no more than about 2.7 mm, more preferably at least about 1.2 mm but no more than about 2.5 mm, and particularly preferably at least about 1.2 mm but no more than about 2.3 mm. Also, the thermal conductivity of the refrigerator resin part 4 in the thickness direction may be preferably 100 mW/m·K or less, more preferably 80 mW/m·K or less, and particularly preferably 70 mW/m-K.

Next, an embodiment of a method and sequence of manufacturing the refrigerator resin part 4 according to the disclosure is described.

The refrigerator resin part 4 may be formed by stretching a resin sheet through vacuum forming.

The resin sheet may be formed by extruding, using an extruder, a three-layer structure sheet in which an inner layer resin composition, a foam layer resin composition, and an outer layer resin composition are sequentially laminated, for example. The inner layer resin composition and the outer layer resin composition include a base resin. The foam layer resin composition includes a base resin and foamable fine particles mixed in the base resin. The foamable fine particles in the foam layer resin composition are foamed during an extrusion process, thereby forming the foam layer before forming shown FIG. 5.

An average thickness of each layer in the state of a resin sheet may be appropriately changed according to the degree of stretching during forming processing to be described below, but may be as follows, for example.

An average thickness of a foam layer in the resin sheet may be preferably at least about 0.5 mm but no more than about 2.5 mm, and more preferably at least about 1.0 mm but no more than about 2.0 mm.

An average thickness of an inner layer in the resin sheet may be preferably at least about 0.5 mm but no more than about 2.5 mm, and more preferably at least about 1.0 mm but no more than about 2.0 mm.

An average thickness of an outer layer in the resin sheet may be preferably at least about 0.1 mm but no more than about 2.0 mm, and more preferably at least about 0.5 mm but no more than about 1.5 mm.

The refrigerator resin part 4 may be manufactured by forming the resin sheet described above by a general vacuum forming method, pressure forming method, blow forming method, etc., for example.

In the case of vacuum forming, the resin sheet is heated by a heater and stretched. In an embodiment, the heater may include a first heater that heats the center of the resin sheet, and a second heater that heats ends of the resin sheet forming ends (e.g., a flange portion 21a in FIG. 3A) of the refrigerator resin part 4. In order to heat the entirety of the resin sheet, the first heater and the second heater may be disposed side by side with no interval, to be spaced apart from the resin sheet at the same distance. Furthermore, a set temperature of the second heater may be set higher than a set temperature of the first heater. In this case, an “end” may be, preferably, within approximately 30 centimeter (cm) from the end of the resin sheet, more preferably within 20 cm, and particularly preferably within 10 cm, for example.

In vacuum forming, pressure forming, blow forming, etc., the resin sheet is pressed into a mold in a stretched state such that the area of the resin sheet becomes about 2 to 5 times greater. In this state, the resin sheet is cooled and hardened in the shape of the mold and may thus be formed as the refrigerator resin part 4. It is identified that the foamed state of the foam layer 41 hardly changes before and after vacuum forming, and the density of the foam layer 41 is maintained before and after forming. The foam layer 41 is in the state after forming shown in FIG. 5.

According to the refrigerator 100 including the aforementioned refrigerator resin part 4, for example, the inner wall member 2, transfer of cold in the space S to be cooled to the outer wall member 1 may be suppressed by the inner wall member 2, in addition to the insulation member 3 between the outer wall member 1 and the inner wall member 2, thereby suppressing cooling of the outer wall member 1. Thus, condensation on the surface of the outer wall member 1 may be suppressed.

Accordingly, condensation may be sufficiently suppressed without placing a heating means, such as a heater, near the door 110 where condensation is likely to occur. Also, wiring for installing a condensation prevention heater, etc. is unnecessary, and the degree of freedom in the design of the refrigerator 100 may be improved.

The refrigerator resin part 4 includes the foam layer 41, and the inner layer 42 and the outer layer 43 that respectively cover opposite sides of the foam layer 41, and the average thickness of each of these layers is set to the appropriate range described above. Thus, the refrigerator resin part 4 may be vacuum formed such that the irregularities of the foam layer 41 do not affect the surface shape of the inner layer 42, and the designability of the interior of the refrigerator 100 may be maintained while sufficiently lowering the thermal conductivity.

By using plurality of heaters during vacuum forming and controlling heating temperature of the plurality of heaters, the ends of the resin sheet, which may easily lack heating, may be sufficiently heated, and during vacuum forming, the entirety of the resin sheet may be uniformly heated and thus uniformly stretched.

Because the resin sheet is uniformly stretched over the entirety of the area including the ends, the shape of closed cells after forming of the refrigerator resin part 4 is completed may also be a flat shape stretched in a direction (i.e., a stretched direction) perpendicular to the thickness direction throughout the refrigerator resin part 4 including ends.

A heat transfer path of the foam layer 41 in the thickness direction follows the outer edge of a cell in the foam layer 41. Because the shape of the cells is flat and extends in a direction perpendicular to the thickness direction, as indicated by an arrow on the right side of FIG. 5, the heat transfer path increases in length and the thermal conductivity of the foam layer 41 may decrease.

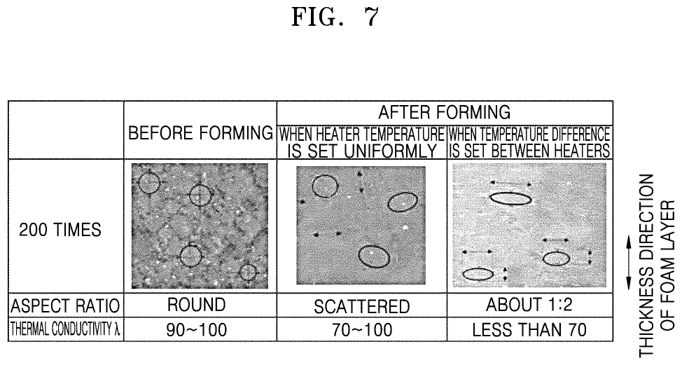

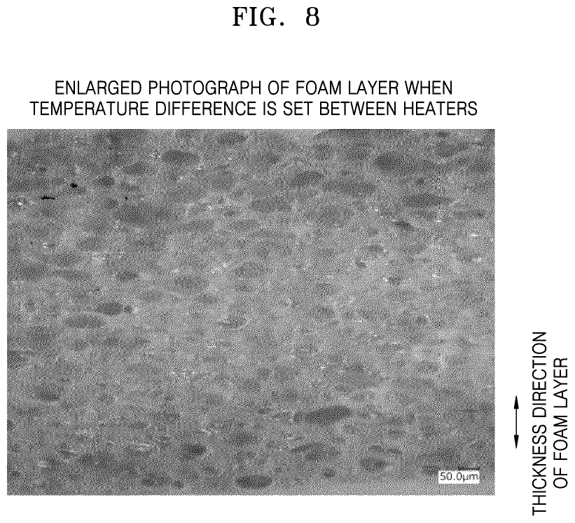

FIG. 7 is a cross-sectional photograph of an embodiment of the foam layer 41 of the refrigerator resin part 4, according to the disclosure. FIG. 8 is an enlarged cross-sectional photograph of an embodiment of the foam layer 41 of the refrigerator resin part 4, according to the disclosure. FIGS. 7 and 8 show actual results of observing the shape of closed cells in the foam layer 41 at the flange portion 21a (refer to FIG. 3A) of the refrigerator resin part 4. As shown in FIG. 7, when a temperature difference is set between the center and the ends of the resin sheet, compared to a case where the temperature difference is not set, it was found that the shape of the closed cells became flat, and the closed cells were also regularly arranged in a direction (stretched direction) perpendicular to a thickness direction of the resin sheet. Also, as a result, it was identified that the thermal conductivity of the flange portion 21a (refer to FIG. 3A), which serves as a connection portion with the outer wall member in the inner box formation member, is also sufficiently reduced.

The disclosure is not limited to the aforementioned embodiments.

In an embodiment, a case where the refrigerator resin part 4 is employed as the inner box formation member 21 has been described in the aforementioned embodiments, but the refrigerator resin part 4 may be another inner wall member that forms the inner surface of the refrigerator 100, for example.

The method of manufacturing the resin sheet is not limited to the extrusion forming method described above. In an embodiment, the resin sheet may be manufactured by other techniques, such as a lamination method in which a foam layer is formed alone and then an inner layer and an outer layer are respectively attached to opposite sides of the foam layer, for example.

Resin (base resin) that forms the foam layer, the inner layer, and the outer layer is not particularly limited. In terms of ease of handling, processing, and forming, the base resin may preferably include one or more thermoplastic resins selected from the group consisting of ABS, PS, polypropylene (PP), polyvinyl chloride (PVC), acrylonitrile-styrene copolymer (AS), and polyethylene (PE), for example, and the compositions of layers may be the same as or different from each other.

For the closed cells, any method may be used as long as the method may form cells of approximately uniform size. The method of forming closed cells is not limited to a method using foamable fine particles. In an embodiment, the closed cells may be formed by methods, such as physical foaming in which, as a foaming agent, nitrogen, carbon dioxide, etc., are mixed into resin and foamed, chemical foaming in which a material mixed with a chemical foaming agent is used and foamed in a mold by gas generated by thermal decomposition, and supercritical fluid foaming using nitrogen gas or carbon dioxide gas, for example.

In the aforementioned embodiment, the plurality of heaters, e.g., the first heater and the second heater, are arranged at the same distance from the resin sheet and the temperatures of these heaters are set differently, but the disclosure is not limited thereto. In an embodiment, any combination of the number of heaters, arrangement type, and set temperature may be suitable as long as the combination makes the temperature of the surface of the resin sheet at the ends of the resin sheet higher than that at the center of the resin sheet such that the entirety of the resin sheet may be uniformly heated during vacuum forming. In an embodiment, the location of the second heater may be closer to the resin sheet than the first heater, and one heater may be used to set the set temperatures at central and peripheral portions of the resin sheet to be different.

In addition, modifications and combinations of the aforementioned embodiments may be made within the scope that does not conflict with the spirit of the disclosure.

Hereinafter, the disclosure is described in more detail based on illustrative embodiments. The embodiments described below are merely embodiments of the disclosure, and the disclosure is not limited to the embodiments described below.

### <Manufacture of Refrigerator Resin Part 4>

In order to examine the effect of an average thickness of the inner layer 42 and a thickness ratio of the inner layer 42 to the outer layer 43 on thermal conductivity of the refrigerator resin part 4 and surface roughness of the outer surface of the inner layer 42, refrigerator resin parts (Embodiments 1 to 6 and Comparative Examples 1 and 2) having different average thicknesses and thickness ratios of the inner layer 42 were manufactured.

First, resin sheets including the foam layer 41, and the inner layer 42 and the outer layer 43, which are respectively provided on opposite sides of the foam layer 41 are formed by extrusion forming. An average thickness of the foam layer 41, the inner layer 42, and the outer layer 43 of each resin sheet was adjusted so that the average thickness of each layer after vacuum forming was the thickness shown in Table 1. The average thickness may be a value obtained by setting as many measurement points as possible from an arbitrary point located in the center of the surface of a resin part to be measured to each end of the surface at a pitch of 20 mm in all directions and averaging thicknesses measured at all of these measurement points.

These resin sheets were vacuum formed under the same conditions to form respective refrigerator resin parts 4 of Embodiments 1 to 4 and Comparative Examples 1 to 2 shown in Table 1 below. All of the resin sheets were stretched by vacuum forming so that the areas thereof are approximately tripled.

The foam layer 41 was formed by a combination of polystyrene with a melt mass-flow rate (MFR) of 2.7 g/10 min, polystyrene with an MFR of 1.0 g/10 min, and foamable fine particles, the MFR being measured by a test method specified in JIS K 7210. The content of foamable fine particles in the foam layer 41 was 10 mass %.

Both the inner layer 42 and the outer layer 43 were formed by ABS.

### <Measurement of Thermal Conductivity>

The thermal conductivity was measured for each refrigerator resin part 4 after forming.

The measurement was performed by a rapid thermal conductivity meter (QTM-710) from Kyoto Electronics Manufacturing Co., Ltd. The results are shown in Table 1.

### <Measurement of Surface Roughness>

Surface roughness (arithmetic mean roughness: Ra) of the inner layer 42 of each refrigerator resin part 4 after forming was evaluated as follows.

The arithmetic mean roughness (Ra) was set as an average value within a range of 30 (three standard deviation) when arbitrary locations (20 points) on the surface of the inner layer 42 of the manufactured refrigerator resin part 4 were measured. The results are shown in Table 1. In Table 1, Comparative Examples 1 and 2 may be referred to as CE1 and CE2, respectively, and Embodiments 1 to 6 may be referred to as E1 to E6, respectively.

TABLE 1

| | | | | CE1 | CE2 | E1 | E2 | E3 | E4 | E5 | E6 |
|---|---|---|---|---|---|---|---|---|---|---|---|
| Average | Inner layer | ABS | mm | 0.36 | 0.47 | 0.60 | 0.65 | 0.67 | 0.69 | 0.60 | 0.68 |
| thickness | Foam layer | PS | mm | 0.70 | 0.50 | 0.47 | 0.58 | 0.88 | 0.68 | 0.66 | 0.81 |
| after vacuum | Outer layer | ABS | mm | 0.35 | 0.46 | 0.24 | 0.33 | 0.37 | 0.34 | 0.30 | 0.37 |
| forming | | | | | | | | | | | |

| | | | | | | | | | |
|---|---|---|---|---|---|---|---|---|---|
| Thickness ratio (A/B) | | 1.0 | 1.0 | 2.5 | 2.0 | 1.8 | 2.0 | 2.0 | 1.8 |
| Total thickness | mm | 1.41 | 1.43 | 1.30 | 1.56 | 1.91 | 1.71 | 1.56 | 1.86 |
| Thermal conductivity | mW/m · K | 63.80 | 69.30 | 65.80 | 69.20 | 71.40 | 61.40 | 66.80 | 69.80 |
| Surface roughness | Ra | 1.02 | 0.53 | 0.34 | 0.18 | 0.16 | 0.18 | 0.18 | 0.16 |

From the results in Table 1, by setting the average thickness of the inner layer 42 to 0.55 mm or more and the thickness ratio (A/B) of the inner layer 42 to the outer layer 43 to 2.5 or less, the surface roughness (Ra) may be set to 0.4 or less, which is a range that may ensure sufficient designability as a product.

When the surface roughness (Ra) is 0.4 or less, the surface of the inner layer 42 may be such that no irregularities are felt at all when a user touches the surface by hand, and even when compared to refrigerator parts of the related art that do not include the foam layer 41, designability that is completely flawless in appearance may be guaranteed.

Also, it was identified that all the refrigerator resin parts 4 showed sufficiently reduced thermal conductivity.

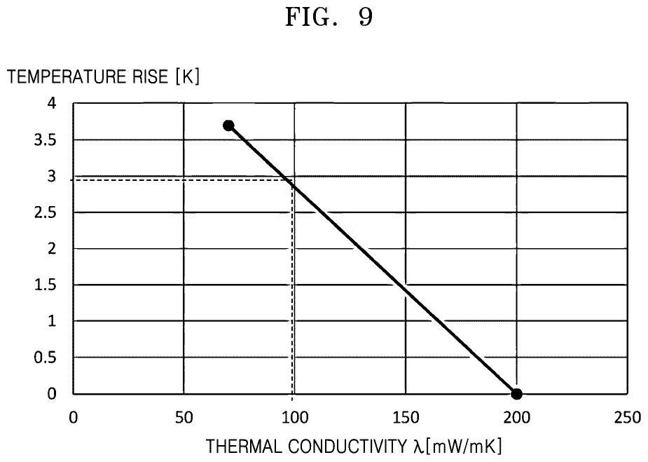

FIG. 9 is a graph showing the relationship between thermal conductivity of the refrigerator resin part 4 and temperature of an outer wall. In particular, from the viewpoint of preventing condensation near the door, the refrigerator resin part 4 needs to have a thermal conductivity that may block cold in the space S to be cooled to the extent that the temperature of an outer wall near the door 110 may rise by 3 K or more. In this viewpoint, referring to FIG. 9, it is considered preferable that the thermal conductivity of the refrigerator resin part 4 is 100 mW/m·K or less.

### <Identification of Energy Saving Effect>

By using the same composition and sequence as in the aforementioned embodiment, an appropriate range of the total thickness of the refrigerator resin part was identified by the refrigerator resin part 4 (herein, an inner box formation member) in which only the total thickness was changed without changing a thickness ratio of each layer.

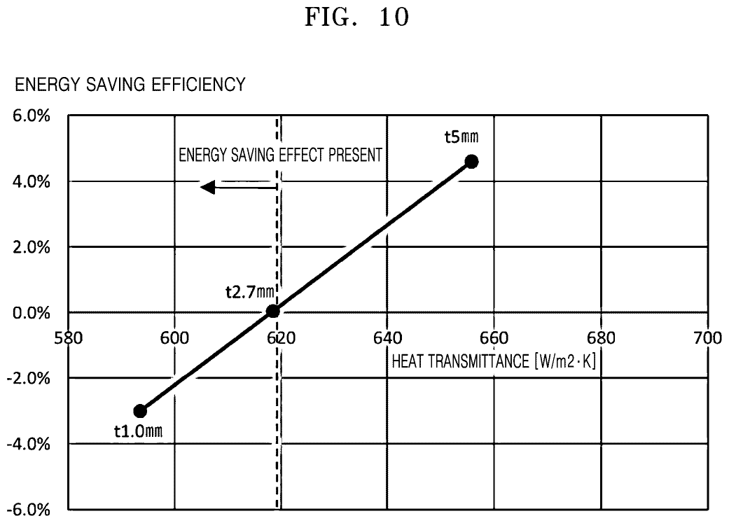

In this experiment, heat transmittance inside and outside the refrigerator was compared with a case of using an inner box of the related art without a foam layer. The heat transmittance was obtained by calculating an average value of heat transmittance respectively measured from the top, bottom, and left and right sides of the refrigerator. FIG. 10 is a graph showing the relationship between an average thickness of the refrigerator resin part 4 and energy saving performance of a refrigerator.

In this experiment, the outer wall member of the refrigerator does not change, and thus, when the total thickness of the refrigerator resin part 4 increases, the amount of filling of the insulation member 3 (urethane foam) filled between the outer wall member 1 and the inner wall member 2 changes.

From the graph of FIG. 10, it was identified that the energy saving effect was able to be improved compared to before by setting the total thickness of the refrigerator resin part 4 with a thermal conductivity of 100 mW/m·K or less to 2.7 mm or less.

In each experiment described above, the content of foamable fine particles in the foam layer 41 was set to 10 mass %. However, the following experiment identified that the thermal conductivity was able to be adjusted to a desired range by changing the density of the foamable fine particles.

The experiment was conducted by manufacturing a plurality of types of refrigerator resin parts 4 that differ from that in the aforementioned embodiment only in the content of the foamable fine particles in the foam layer 41.

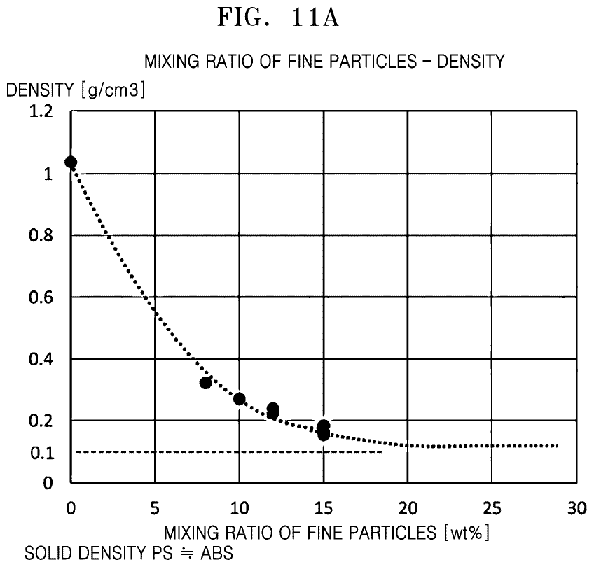

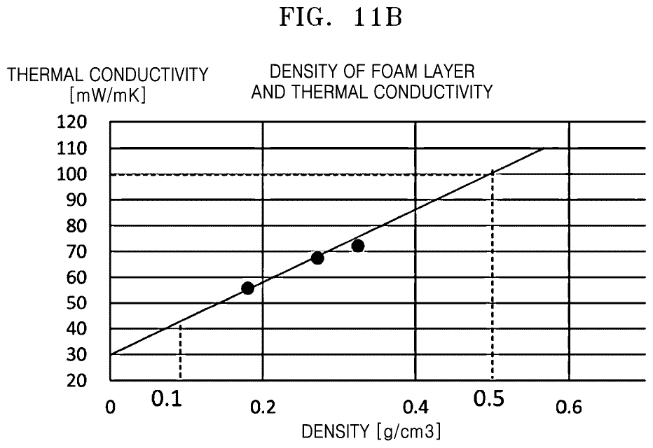

FIG. 11A is a graph showing the relationship between a mixing ratio of foamable fine particles in the foam layer 41 and density of the foam layer 41. FIG. 11B is a graph showing the relationship between density of the foam layer 41 and thermal conductivity of the foam layer 41. As shown in FIG. 11A, it was identified that, when the content of the foamable fine particles in the foam layer 41 increases, the density of the foam layer 41 decreases.

Also, it was found that, when the density of the foam layer 41 was changed by changing the content of the foamable fine particles in the foam layer 41, the density and thermal conductivity showed a relatively high correlation, as shown in FIG. 11B.

From these results, it was seen that, when the foam layer 41 foamed using the foamable fine particles is used, the thermal conductivity of the refrigerator resin part 4 was able to be adjusted to a desired range by adjusting the content of the foamable fine particles in the foam layer 41.

The disclosure provides a refrigerator having improved low thermal conductivity of an inner wall member. Also, the disclosure provides a refrigerator having improved designability of an inner wall member.

In an embodiment of the disclosure, a refrigerator includes an outer wall member forming an outer wall of a main body, an inner wall member disposed inside the outer wall member and forming a space to be cooled; and an insulation member between the outer wall member and the inner wall member, wherein at least a portion of the inner wall member includes a foam layer including a closed cell formed by foamable fine particles, and an inner layer and an outer layer respectively laminated on opposite sides of the foam layer.

In an embodiment, an average thickness of the inner layer may be 0.55 mm or more, and a ratio (A/B) of the average thickness (A) of the inner layer to an average thickness (B) of the outer layer may be 2.5 or less.

In an embodiment, a density of the foam layer may be at least 0.1 g/cm³ and no more than 0.5 g/cm³.

In an embodiment, a sum of an average thickness of the foam layer, an average thickness the inner layer, and an average thickness the outer layer may be 2.7 mm or less.

In an embodiment, an average diameter of the closed cell may be 200 μm or less.

In an embodiment, the closed cell may have a flat shape in a direction perpendicular to a thickness direction of the foam layer.

In an embodiment, a ratio (D/C) of a length (C) of a major axis to a length (D) of a minor axis of the closed cell may be 0.9 or less.

In an embodiment, the ratio (D/C) may be 0.2 or more.

In an embodiment, a maximum inclination of a major axis of the closed cell with respect to a direction perpendicular to a thickness direction of the foam layer may be within ±15 degrees.

In an embodiment, an average thickness (E) of the foam layer, an average thickness (A) of the inner layer, and an average thickness (B) of the outer layer may satisfy E/(A+B)≤1.0.

In an embodiment, an average thickness of the foam layer may be 0.3 mm or more.

In an embodiment, a thermal conductivity of at least one of the inner layer and the outer layer in a thickness direction may be 300 mW/m·K or less.

In an embodiment, at least one of the foam layer, the inner layer, and the outer layer may include at least one resin selected from a group consisting of acrylonitrile-butadiene-styrene copolymer (ABS), polystyrene (PS), polypropylene (PP), polyvinyl chloride (PVC), acrylonitrile-styrene copolymer (AS), and polyethylene (PE).

In an embodiment, the foam layer, the inner layer, and the outer layer may include a high strain hardening resin.

In an embodiment, the foam layer, the inner layer, and the outer layer may include a same base resin as each other.

By the embodiments of the refrigerator according to the disclosure, a refrigerator including an inner wall member, wherein sufficient designability is ensured by suppressing the formation of irregularities on the outer surface of an inner layer while reducing thermal conductivity by a foam layer, may be provided. In addition, because insulation effect may be obtained not only by an insulation member between an inner wall member and an outer wall member but also by the inner wall member, the amount of heat leaking out from the inside of the refrigerator may be reduced. As a result, the occurrence of condensation near a door may be reduced without having a heater or the like.

As described above, although the refrigerator of the disclosure has been described with reference to the limited embodiments and drawings, various modifications and variations may be made from the above description by those skilled in the art.

What is claimed is:

1. A refrigerator comprising:
an outer wall member forming an outer wall of a main body;
an inner wall member disposed inside the outer wall member and defining a space which is cooled, at least a portion of the inner wall member comprising:
a foam layer including a closed cell; and
an inner layer and an outer layer respectively laminated on opposite sides of the foam layer; and
an insulation member between the outer wall member and the inner wall member.

2. The refrigerator of claim 1, wherein
an average thickness of the inner layer is 0.55 millimeter or more, and
a ratio of the average thickness of the inner layer to an average thickness of the outer layer is 2.5 or less.

3. The refrigerator of claim 1, wherein
a density of the foam layer is at least 0.1 gram per cubic centimeter and no more than 0.5 gram per cubic centimeter.

4. The refrigerator of claim 1, wherein
a sum of an average thickness of the foam layer, an average thickness of the inner layer, and an average thickness of the outer layer in a thickness direction is 2.7 millimeter or less.

5. The refrigerator of claim 1, wherein
an average diameter of the closed cell is 200 micrometers or less.

6. The refrigerator of claim 1, wherein
the closed cell has a flat shape in a direction perpendicular to a thickness direction of the foam layer.

7. The refrigerator of claim 1, wherein
a ratio of a length of a major axis to a length of a minor axis of the closed cell is 0.9 or less.

8. The refrigerator of claim 7, wherein
the ratio is 0.2 or more.

9. The refrigerator of claim 1, wherein
a maximum inclination of a major axis of the closed cell with respect to a direction perpendicular to a thickness direction of the foam layer is within +15 degrees or less.

10. The refrigerator of claim 1, wherein
an average thickness of the foam layer, an average thickness of the inner layer, and an average thickness of the outer layer satisfy Formula (1) below:
$$E / ( A + B ) \leq 1. , \qquad ( 1 )$$
where E denotes the average thickness of the foam layer, A denotes the average thickness of the inner layer, and B denotes the average thickness (B) of the outer layer.

11. The refrigerator of claim 1, wherein
an average thickness of the foam layer is 0.3 millimeter or more.

12. The refrigerator of claim 1, wherein
a thermal conductivity of at least one of the inner layer and the outer layer in a thickness direction is 300 milliwatts per meter-kelvin or less.

13. The refrigerator of claim 1, wherein
at least one of the foam layer, the inner layer, and the outer layer include at least one resin selected from a group consisting of acrylonitrile-butadiene-styrene copolymer (ABS), polystyrene (PS), polypropylene (PP), polyvinyl chloride (PVC), acrylonitrile-styrene copolymer (AS), and polyethylene (PE).

14. The refrigerator of claim 1, wherein
at least one of the foam layer, the inner layer, and the outer layer include a high strain hardening resin.

15. The refrigerator of claim 1, wherein
the foam layer, the inner layer, and the outer layer include a same base resin as each other.
